(19) United States
(12) Patent Application Publication
(10) Pub. No.: US 2006/0163851 A1
(43) Pub. Date: Jul. 27, 2006

(54) Seat-integrated side gas bag restraint system

(75) Inventors: Christof Werner, Mutlangen (DE); Dominique Acker, Gschwend (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/338,954

(22) Filed: Jan. 25, 2006

(30) Foreign Application Priority Data
Jan. 26, 2005 (DE) 10 2005 003 706.2

(51) Int. Cl. B60R 21/207

(52) U.S. Cl. 280/730.2

(57) ABSTRACT

In a seat-integrated side gas bag restraint system having a side gas bag (12) and a gas generator (14) that is arranged within the side gas bag (12), the gas generator (14) is joined to a vehicle-fixed component (28) via the side gas bag (12) only.

### FIELD OF THE INVENTION

The present invention relates to a seat-integrated side gas bag restraint system.

### BACKGROUND OF THE INVENTION

A gas bag module in a restraint system has to satisfy multiple requirements. For example, It is required to be as compact as possible in order to optimally exploit the small installation space that is available in the vehicle. Additionally, for obvious reasons, both the gas bag as well as the gas generator must be fixedly and securely joined to the vehicle.

Often, the gas generator is used for attaching the gas bag module either in a housing or directly to a vehicle-fixed component. For example, attachment bolts protruding from the gas generator or clamps that encircle the gas generator are used for this purpose. However, in these designs, components that are usually in addition to the gas bag and gas generator are required, and the attachment options are dictated by the geometry of the gas generator or the clamp.

It is an object of the present invention to provide a restraint system that is cost-effective to manufacture and flexible to use.

### BRIEF SUMMARY OF THE INVENTION

This is achieved in a seat-integrated side gas bag restraint system with a side gas bag and a gas generator arranged inside the gas bag in that the gas generator is joined to a vehicle-fixed component via the gas bag only. Both the side gas bag and the gas generator are therefore held on a vehicle-fixed component like a vehicle seat by the side gas bag alone. As a result, the entirety of the generated forces are transferred from the side gas bag to the vehicle-fixed component. The gas generator is only and exclusively attached to the side gas bag itself but not directly to the vehicle-fixed component or to a housing. One advantage of this arrangement, among others, lies in the possibility of configuring the attachment to the vehicle in a very flexible manner, because the attachment points are predetermined by the side gas bag. In addition, the number of required individual components can be kept to a minimum. By providing the attachment points on the side gas bag, it is also possible to optimize the installation space in a very simple manner.

Preferably, the gas generator is fixed in position with respect to the vehicle-fixed component at all times. It is advantageous to arrange the gas generator adjacent a wall of the side gas bag, in a deployed state of the side gas bag.

The side gas bag and the gas generator are preferably components of a gas bag module, and the gas bag module is only joined to the vehicle-fixed component via the gas bag. The gas bag module is preferably arranged in a seat back.

In the restraint system according to the present invention, it is possible to do without a separate housing. As a result, a further component is rendered unnecessary, which reduces both weight and cost. It is possible to form an exterior border of the gas bag module using a fabric layer. The fabric layer can be a part of the side gas bag itself or a supplemental protective sleeve, which surrounds the folded gas bag packet and opens at a predetermined location when the gas bag module is activated so as to release the side gas bag. The gas bag module consists then essentially of only the gas generator and the folded side gas bag.

The attachment of the gas generator can be realized, e.g., by at least one rivet connection, but also by at least one bolt, which can protrude from the gas generator, for example, in the radial or axial direction. However, in contrast to the prior art, this bolt only serves to attach the gas generator to the side gas bag, but not to attach the gas generator to a housing or to the vehicle itself.

The side gas bag is advantageously attached to the vehicle-fixed component by at least one attachment element that is joined to the fabric of the side gas bag. For this purpose, for example, one or more metal eyelets can be attached to the side gas bag at the individual attachment points through which then a conventional screw or locking connection to the vehicle-fixed component is accomplished. The eyelets can be arranged, e.g., in separately taken-in, non-inflatable, and reinforced sections of the side gas bag. Preferably, the attachment elements are located in the immediate vicinity of the gas generator. The arrangement of the attachment elements on the side gas bag permits the gas bag module to be attached to the vehicle-fixed component in a flexible and spatially optimized manner and at various installation positions, e.g., in various vehicle parts or various vehicle types. As attachment elements for attaching the gas bag to the vehicle, it is possible also to use eyelets or disks that have press-in bolts or threaded bolts that are attached on it.

According to the invention, the side gas bag is integrated into a vehicle seat. Preferably the side gas bag is attached to a seat back frame.

### BRIEF DESCRIPTION OF THE DRAWINGS

FIG. 1 depicts a top view of a gas bag module of a restrain system according to the present invention;

FIG. 2 depicts a side view of the gas bag module from FIG. 1;

FIG. 3 depicts a schematic view of the spread-out gas bag from FIG. 1 having an installed gas generator;

FIG. 4 depicts a sectional view of a side part of a vehicle seat with a side gas bag restraint system according to the invention; and

FIG. 5 depicts a sectional view along the line V-V in FIG. 4.

### DETAILED DESCRIPTION OF A PREFERRED EMBODIMENT

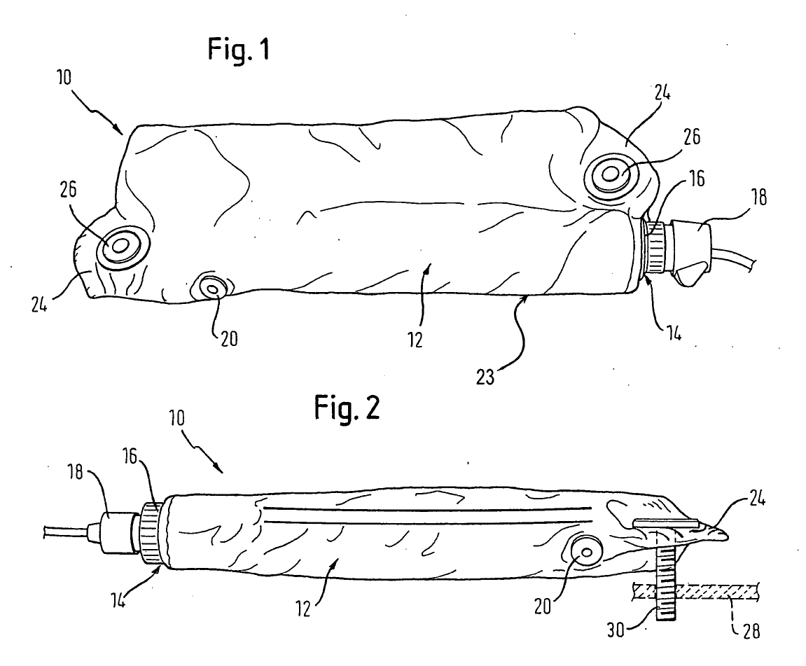

In FIG. 1, an assembly is depicted that is made up of a side gas bag 12 and a gas generator 14, which is accommodated in the interior of gas bag 12. The side gas bag may contain two or more fabric layers connected to form at least one inflatable chamber. Side gas bag 12 and gas generator 14 are component parts of a gas bag module 10, which in turn is part of a vehicle occupant restraint system. Gas bag module 10 in this case is made up essentially of side gas bag 12 and gas generator 14.

“Accommodated” is here understood to mean that the gas generator 14, at least for the greater part of its length, and at the very least with its gas outlet area, is arranged in the side gas bag 12 itself. In the present exemplary embodiment, only an igniter section 16 of gas generator 14 protrudes from side gas bag 12 so as to make it easier to contact with a plug 18 and a cable situated thereon that leads to a control electronics (not shown).

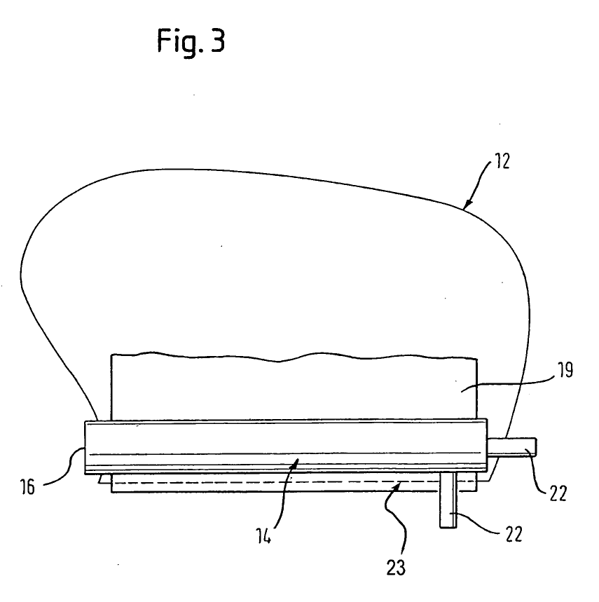

Side gas bag 12 is folded to form a packet and, in the folded state, is fixed in position and protected by a fabric layer 19 (sketched in FIG. 3), as is familiar from the prior art.

Gas generator 14 is attached to side gas bag 12 by an attachment 20, here a rivet connection. In place of or in addition to the rivet connection, it is also possible to use bolts 22 (see FIG. 3) that protrude radially or axially from gas generator 14, in order to join side gas bag 12 to gas generator 14. It would be possible to arrange gas generator 14 in a pocket in side gas bag 12. Attachment 20 keeps gas generator 14 always in direct vicinity to a portion of a wall 23 of the side gas bag 12. Gas generator 14 is arranged adjacent to wall 23, in a non-inflated condition of side gas bag 12 as well as in an inflated condition. It is possible to place a reinforcement or protection layer between gas generator 14 and wall 23.

Gas bag 12 is reinforced at sections 24, two in the depicted example, and each of them is provided with a metal eyelet as an attachment element 26. Sections 24 constitute attachment points via which gas bag module 10, in the installed state, is joined to a vehicle-fixed component 28, here a vehicle seat (only sketched in FIG. 2). For this purpose, for example, as indicated in FIG. 2, conventional screws 30 can be used, or attachment elements 26 can be directly provided with press-in bolts or press-in screws. Gas generator 14 is always fixed in position with respect to the vehicle-fixed component 28 to which gas bag module 10 is attached and, therefore, moves as little as possible with respect to this component.

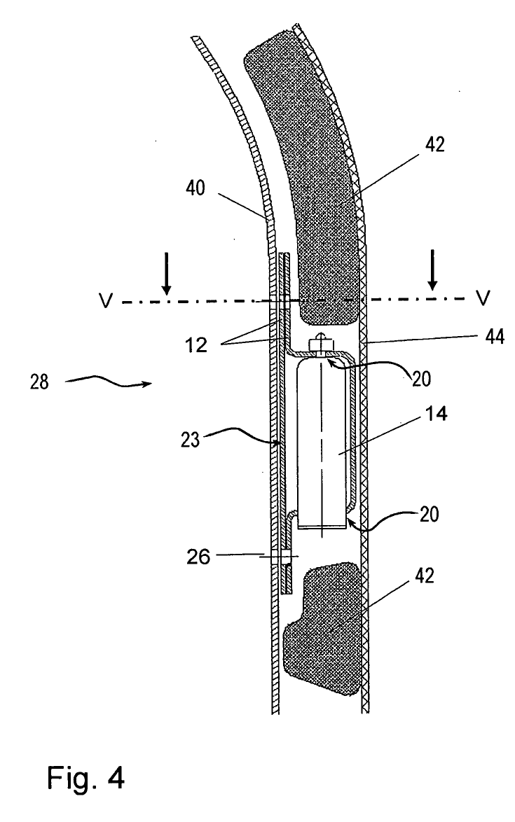

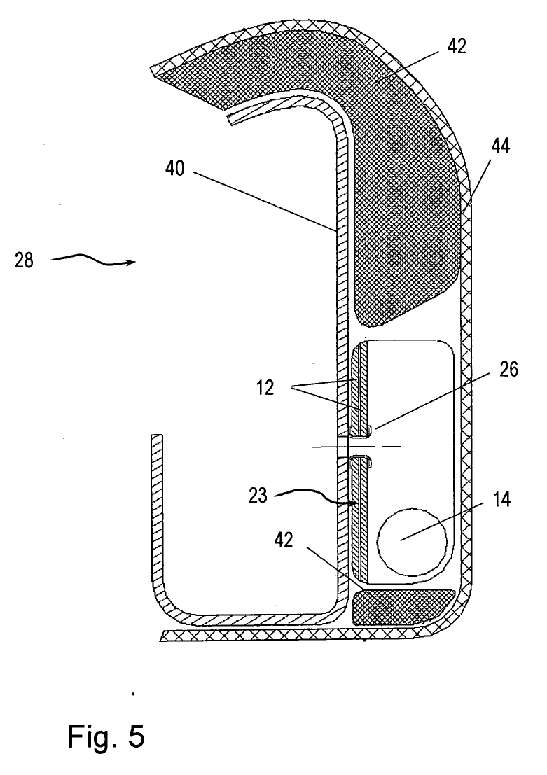

In FIGS. 4 and 5 the gas bag module 10 is shown integrated into a side part of a vehicle seat. Side gas bag 12 is firmly connected with a seat back frame 40 via the attachment elements 26. Seat back frame 40 is covered with a layer 42 made of foam having a recess for receiving gas bag module 10. Layer 42 and gas bag module 10 are covered by a seat cover 44. Seat cover 44 may be provided with a predetermined breaking point as known in the art. On activation of gas bag module 10, side gas bag 12 deploys from its recess to serve as a protection for the vehicle occupant.

Gas bag module 10 according to the present invention is installed in the vehicle without the use of a separate supplementary housing on seat back frame 40. Gas bag module 10 therefore is made up of only side gas bag 12 and gas generator 14 (as well as fabric layer 19 in this case). It is also possible to do without a diffuser housing around gas generator 14. However, it is also conceivable to arrange folded side gas bag 12 partially or completely within a housing.

1. A seat-integrated side gas bag restraint system having a side gas bag (12) and a gas generator (14) that is arranged within the gas bag (12),
wherein the restraint system is integrated into a vehicle seat and
the gas generator (14) is joined to a vehicle-fixed component (28) via the side gas bag (12) only.

2. The seat-integrated side gas bag restraint system as recited in claim 1, wherein the gas generator (14) is arranged adjacent to a wall (23) of the side gas bag (12) in an inflated condition of the side gas bag (12).

3. The seat-integrated side gas bag restraint system as recited in claim 1, wherein the side gas bag (12) and the gas generator (14) are components of a gas bag module (10), and the gas bag module (10) is only joined to the vehicle-fixed component (28) via the side gas bag (12).

4. The seat-integrated side gas bag restraint system as recited in claim 3, wherein an exterior border of the gas bag module (10) is formed by a fabric layer (19).

5. The seat-integrated side gas bag restraint system as recited in claim 1, wherein the gas generator (14) is attached to the gas bag (12) by at least one rivet connection.

6. The seat-integrated side gas bag restraint system as recited in claim 1, wherein the gas generator (14) is attached to the side gas bag (12) by at least one bolt (22).

7. The seat-integrated side gas bag restraint system as recited in claim 1, wherein at least one attachment element that is joined to the fabric of the side gas bag (12) is provided on the side gas bag (12).

8. The seat-integrated side gas bag restraint system as recited in claim 1, wherein the side gas bag (12) is fastened to a seat back frame (40) of a vehicle seat.
